(19) United States
(12) Patent Application Publication
(10) Pub. No.: US 2003/0210355 A1
(43) Pub. Date: Nov. 13, 2003

(54) Electronic adjustable window tinting system

(76) Inventor: Hank Tien Dao, Houston, TX (US)

Correspondence Address: Mr. Hank T. Dao, 2515 Hyland Park, Houston, TX, 77014, US

(21) Appl. No.: 10/143,179

(22) Filed: May 13, 2002

(51) Int. Cl. G02F 1/1335

(52) U.S. Cl. 349/16

(57) ABSTRACT

An Electronic Adjustable Tinting Window comprised of a large-scale liquid crystal segment that forms a shape of a window. The large-scale liquid crystal segment consisted of two polarized filters with liquid crystal molecules arranged between the two polarized filters. A control system comprised of a control switch, solar radiation sensor, temperature sensor, a control unit, and a new Electronic Adjustable Tinting Window.

### DESCRIPTION

### BACKGROUND OF THE INVENTION

1. Field of the Invention

The present invention relates to a window tinting device and its control system to automatically tint a window to various degrees with respect to the amount of sun light thereby limiting the amount of light and heat that pass through a window under sunny condition and maintain good visibility under cloudy condition.

2. Description of the Prior Art

Tinted windows have proven to have many advantages. They limit the amount of light and heat, and cut glare in interior spaces. Furthermore, tinted windows have been used to facilitate privacy and enhance the appearance of buildings and automobiles.

Tinted windows, adjustable window tinting, and Shading devices are produce in several ways. Windows may be manufactured with specific elements therein which provide the completed glass with proper tinting. Alternatively, a darkened sheet of film is applied to the glass either at its time of manufacture or when the glass is placed in its end use.

Shading Devices is known in the prior art. More specifically, Shading Devices heretofore devised and utilized are known to consist of obvious structural configurations.

Known prior art Shading Devices include U.S. Pat. No. 4,641,922; U.S. Pat. No. 5,390,045; U.S. Pat. No. 5,009,044; U.S. Pat. No. 4,696,547; U.S. Pat. No. 4,456,335 and U.S. Pat. No. 5,406,414.

The prior art of an adjustable window tinting device is also known. Such device comprised of two panes of glass, a darkening means, which separates and merges the two panes of glass, and an opaque fluid that enters the two panes of glass at various thickness depending upon the amount of separation of the two panes of glass.

The prior art of Liquid crystal display, from here on refers to as LCD, technology is known for displaying information. Such information is displayed by numbers and letters. These numbers and letters are display by turning on and off individual or multiple LCD segments. The principle of operation of LCD segment is described hereon. A structure of LCD is comprised of two polarized plates with liquid crystal molecules arranged between the plates. Behind the two polarized plates is a non-transparent color filter. The color filter is illuminated by a light bulb to form an LCD background color.

Pertaining to how an LCD segment is lit up. The two polarized plates are constructed to be 90 degrees from one another. Under a normal state, the liquid crystal molecules are arranged to twist the light by 90 degree, therefore allowing light to pass through from one polarized plate to another. When a certain voltage is applied to the liquid crystal segment, the liquid crystal molecules are raised and therefore the light is cut by the second polarized plate, which result a black segment.

While these tinted window, adjustable window tinting, and shading devices fulfill their respective, particular objectives and requirements, the aforementioned window tinting devices do not disclose a new Electronic Adjustable Window Tinting System. The device utilized the principle operation of an LCD segment and applied it to a window to form a new Electronic Adjustable Window Tinting System. A new Electronic Adjustable Window Tinting System comprised of a large scale LCD segment that would form a shape of a window, or multiple large scale LCD segments structured to form a shape of a window. Such large-scale LCD segment includes of two polarized filters with liquid crystal molecules arranged between the filters. The two polarized filters are arranged 90 degree from one another. Under a state of no voltage applied to the liquid crystal segment, herein refer to as normal state, the liquid crystal molecules are arranged to twist the light by 90 degree, therefore allowing light to pass through from one polarized filter to another. When a certain voltage is applied to the liquid crystal segment, the liquid crystal molecules are raised and therefore light is passed through the first polarized filter, but cut by the second polarized filter. In result, a black segment. The various degrees of tint are thus attained from varying the applied voltage thus varies the amount the liquid crystal molecules are raised.

In these respects, a new Electronic Adjustable Window Tinting System departs from the conventional concepts and designs of the prior window tinting system, and in so doing provides an apparatus primarily developed for the purpose of tinting a window to various degrees of tint thereby limiting the amount of light and heat that pass through a window.

### SUMMARY OF THE INVENTION

In view of the disadvantages in the prior art, the present invention provides a new Electronic Adjustable Window Tinting System that tint a window to various degrees, depends on the amount of sunlight, thereby limit the amount of glare, light, and heat. Such system will be described subsequently in greater detail to present a new Electronic Adjustable Window Tinting System apparatus and method which has many of the advantages over, but not to anticipated, rendered, obvious, suggested, or even implied by any of the prior art.

To accomplish this, the present invention utilized the principle operation of an LCD segment and applied it to a window to form a new Electronic Adjustable Window Tinting System. A new Electronic Adjustable Window Tinting System comprised of a large scale LCD segment that would form a shape of a window, or multiple large scale LCD segments structured to form a shape of a window. Such large-scale LCD segment comprised of two polarized filters with liquid crystal molecules arranged between the filters. The two polarized filters are arranged 90 degree from one another. Under a state of no voltage applied to the liquid crystal segment, normal state, the liquid crystal molecules are arranged to twist the light by 90 degrees, therefore allowing light to pass through from one polarized filter to another. When a certain voltage is applied to the liquid crystal segment, the liquid crystal molecules are raised and therefore light is passed through the first polarized filter, but cut by the second polarized filter. In result, a black segment. The various degrees of tint are thus attained from varying the applied voltage thus varies the amount the liquid crystal molecules are raised.

In contrast of a clear liquid crystal segment (clear window) under normal state, the polarized filters could be arranged in such a way that resulted in a black liquid crystal segment under a normal state. To attain this, the device comprised of two polarized filters that are arranged at zero degree from one another with liquid crystal molecules arranged between the filters. Under the normal state, the liquid crystal molecules are arranged to twist the light by 90 degrees. Light is therefore pass through the first polarized filter, twisted 90 degrees by the liquid crystal molecules and blocked by the second polarized filter, which resulted in a black segment or a tinted window.

The liquid crystal segment could be made to the size and shape of the window or multiple large segments could be arranged together to form the size and shape of the window. When multiple liquid crystal segments are used, the window therefore is able to be partition in sections of different amount of tint.

The new Electronic Adjustable Tinting Window control system consisted of a new Electronic Adjustable Tinting Window, a solar radiation sensor, an ambient temperature sensor, a control switch, and a control unit. The control unit comprised of a microprocessor, interface circuits that interface the control switch and sensors to the microprocessor, and the LCD driver circuit that deliver the voltage to the liquid crystal segment(s) in the Electronic Adjustable Tinting Window. With the inputs of the solar radiation and ambient temperature sensors and control switch setting via the interface circuits, the microprocessor calculates a voltage for the liquid crystal segment that corresponds to the degree of tint with respect to the amount of sunlight and outputs the voltage to the liquid crystal segment driver circuit. The LCD driver circuit then delivers the voltage to the liquid crystal segment in the Electronic Adjustable Tinting Window.

### BRIEF DESCRIPTION OF THE DRAWINGS

The invention will be better understood and objects other than those set forth above will become apparent when consideration is given to the following detailed description thereof. Such description makes reference to the drawings wherein:

FIG. 1 is a zoom in view of how light travels through a new Electronic Adjustable Tinting Window. At normal state, this window is clear. It is illustrated that light is passed through the first polarized filter, twisted 90 degree by the liquid crystal and exit through the second polarized filter. In this window, the two polarized filters are set 90 degrees from one another.

FIG. 2 showed a new Electronic Adjustable Tinting Window that is tinted black at normal state. A zoom in view illustrated that light is passed through the first polarized filter, twisted 90 degree by the liquid crystal and blocked by the second polarized filter. In this window, the two polarized filters are set 0 degree from one another.

FIG. 3 is a cross section and a side view of a new Electronic Adjustable Tinting Window. The cross sectional view showed the layer construction of glass, polarized filters, and liquid crystal. The side view showed two liquid crystal segments assemble side by side to form a window. It is also showed that with multiple segments, a window could be partition with different tint.

FIG. 4 showed a control system for a new Electronic Adjustable Tinting Window. Such system comprised of a control switch, solar radiation sensor, temperature sensor, a control unit, and a new Electronic Adjustable Tinting Window.

### DESCRIPTION OF THE PREFERRED EMBODIMENT

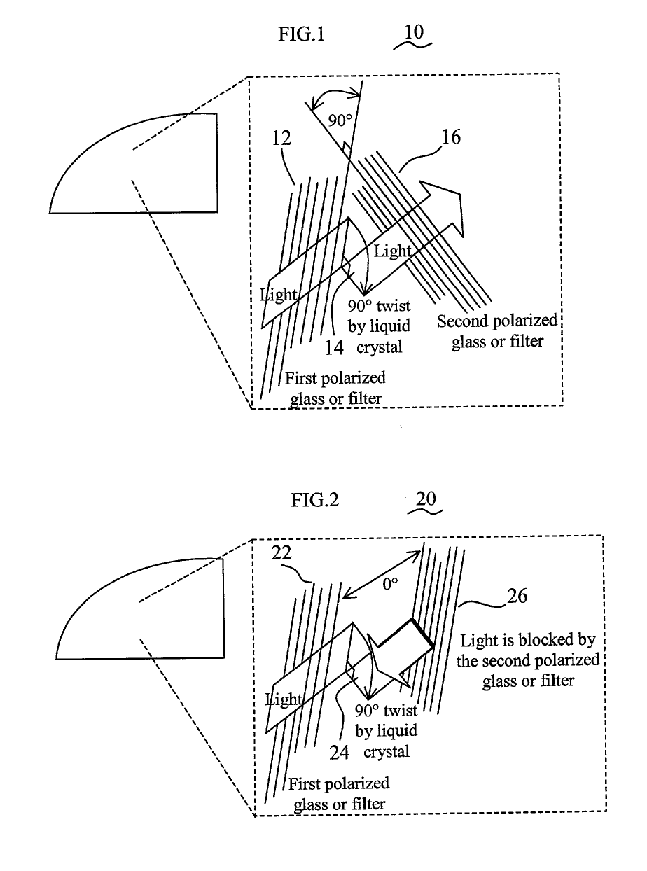

With reference to FIGS. 1 through 4 thereof, the present invention system embodying the principles and concepts are illustrated.

More specifically, FIG. 1 illustrated the concept of a new Electronic Adjustable Tinting Window 10 being clear at normal state. The window 10 comprised of two polarized filters 12 and 16 with liquid crystal molecules 14 arranged between polarized filters 12 and 16. Polarized filter 12 is arranged 90° from polarized filter 16. At normal state, liquid crystal molecules 14 are arranged to twist light by 90°. When light passed through polarized filter 12, it is then twist 90° by liquid crystal 14 and exit through polarized filter 16. When a voltage is applied to the liquid crystal segment, the liquid crystal molecules 14 are raised and thus light is no longer twisted by 90°. Therefore light is passed through the first polarized filter 12, but cut by the second polarized filter 16, which resulted a black liquid crystal segment or a tinted window. The degree of tint is thus attained by varying the applied voltage to the liquid crystal segment.

In contrast to the configuration of a new Electronic Adjustable Tinting Window 10, the configuration of a new Electronic Adjustable Tinting Window 20 in FIG. 2 illustrated the concept of an adjustable tinting window being tinted at normal state. The new Electronic Adjustable Tinting Window 20 comprised of polarized filters 22 and 26 with liquid crystal molecules 24 arranged between polarized filters 22 and 26. The polarized filter 22 is arranged at 0° from the polarized filter 26. The liquid crystal molecules 24 are arranged to twist light by 90°. With a new Electronic Adjustable Tinting Window 20 configuration, light is passed through the first polarized filter 22, then twist 90° by liquid crystal molecules 24, and then blocked by the second polarized filter 26, which result in a tinted window 20. When a voltage is applied to the liquid crystal segment, light is no longer twisted by the liquid crystal molecules 24 and thus light is able to pass from the first polarized filter 22 through the second polarized filter 26, which resulted a clear window 20. The degree of tint is thus attained by varying the applied voltage to the liquid crystal segment.

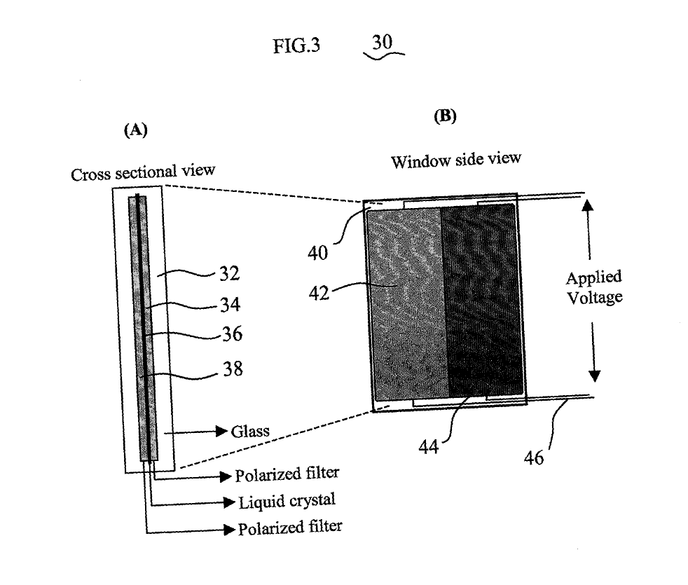

FIG. 3 illustrated a cross section and a side view of a new Electronic Adjustable Tinting Window 30. A side view illustrated a new Electronic Adjustable Tinting Window 30 comprised of two liquid crystal segments 42 and 44. With this configuration, the liquid crystal segment 42 could be set at different tint from liquid crystal segment 44. Each liquid crystal segment 42 and 44 has two wire leads 46 where voltage is applied for the tinting. A cross sectional view of a new Electronic Adjustable Tinting Window 30 illustrated that liquid crystal 36 is sandwiched between two polarized filters 34 and 38. It is then covered by substantially rigid clear glass 32.

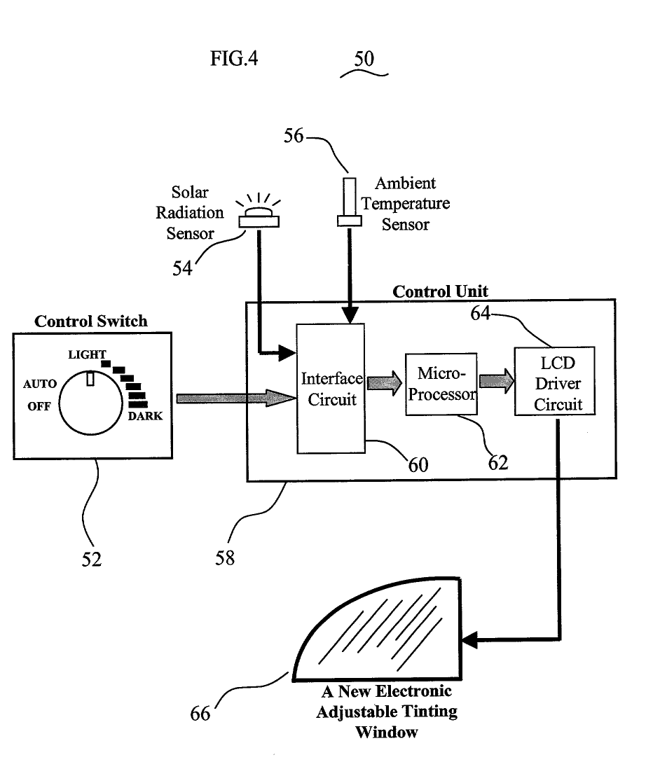

FIG. 4 illustrated a control system 50 for a new Electronic Adjustable Tinting Window 66. The control system 50 comprised of a control switch 52 which send the user setting of OFF, AUTO, manual setting of LIGHT to DARK to the control unit 58. The control unit 58 takes inputs of a control switch 52, the solar radiation sensor 54 and ambient temperature sensor 56 via the interface circuit 60 to the microprocessor 62. The microprocessor 62 then calculates a voltage for the liquid crystal segment that corresponds to the degree of tint with respect to the amount of sunlight. After the calculation, the microprocessor 62 outputs the voltage to the LCD driver circuit 64 which drive the liquid crystal segment in a new Electronic Adjustable Tinting Window. an Electronic Adjustable Tinting Window, consisted of a large-scale liquid crystal segment that forms a shape of a window. Such large-scale liquid crystal segment

What is claimed as being new and desired to be protected by Letters Patent of the United States is as follows:

1. Liquid crystal segment used for window tinting device. Such device, known as an Electronic Adjustable Tinting Window, consisted of a large-scale liquid crystal segment that forms a shape of a window. Such large-scale liquid crystal segment comprised of two polarized filters with liquid crystal molecules arranged between the two polarized filters. Each liquid crystal segment contains two wire leads where a driving voltage is applied. Securing the liquid crystal segment and the wire leads is the substantially rigid clear glass.

2. An Electronic Adjustable Tinting Window device in claim 1 wherein the two polarized filters in the liquid crystal segment are arranged 90 degrees from one another. Such configuration permits light to pass through the window when no voltage is applied to the liquid crystal segment (clear window).

3. An Electronic Adjustable Tinting Window device in claim 1 wherein the two polarized filters in the liquid crystal segment are arranged 0 degree from one another. Such configuration limit light to pass through the window when no voltage is applied to the liquid crystal segment (dark window).

4. An Electronic Adjustable Tinting Window device in claim 1 wherein comprised of multiple large-scale liquid crystal segments that form a shape of a window. Such configuration allowed said one segment to be tint at a different tint than the other segments.

5. A control system for an Electronic Adjustable Tinting Window device. Such control system comprised of a control switch, a solar radiation sensor, an ambient temperature sensor, a control unit and an Electronic Adjustable Tinting Window.
